(19) United States
(12) Patent Application Publication
(10) Pub. No.: US 2008/0191973 A1
(43) Pub. Date: Aug. 14, 2008

(54) METHOD OF DRIVING PLASMA DISPLAY APPARATUS

(76) Inventor: Byungjoon Rhee, Seoul (KR)

Correspondence Address: KED & ASSOCIATES, LLP, P.O. Box 221200, Chantilly, VA, 20153-1200, US

(21) Appl. No.: 12/026,181

(22) Filed: Feb. 5, 2008

(30) Foreign Application Priority Data
Feb. 9, 2007 (KR) 10-2007-0014010

(51) Int. Cl. G09G 3/28

(52) U.S. Cl. 345/67

(57) ABSTRACT

A method of driving a plasma display apparatus is disclosed. The method includes supplying a first reset signal to a scan electrode during a reset period of a first subfield of a plurality of subfields of a frame, and supplying a second reset signal, whose a peak voltage is lower than a peak voltage of the first reset signal, to the scan electrode during reset periods of the remaining subfields except the first subfield when a data signal is not supplied to the address electrode during address periods of the remaining subfields. The first subfield is first arranged in the plurality of subfields in time order.

This application claims the benefit of Korean Patent Application No. 10-2007-0014010 filed on Feb. 9, 2007, which is hereby incorporated by reference.

### BACKGROUND

1. Field

An exemplary embodiment relates to a method of driving a plasma display apparatus.

2. Description of the Background Art

Out of display apparatuses, a plasma display apparatus includes a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

Because a rising signal supplied to a scan electrode during a reset period is a high-voltage signal, the quantity of light generated by a discharge generated by the rising signal relatively increases.

Thus, a luminance (i.e., a black level luminance) in an OFF state of all the discharge cells of the plasma display panel relatively increases. This results in a degradation of a contrast characteristic and the generation of image retention.

Accordingly, a method to apply the rising signal in only one subfield of one frame was proposed, and thus can partially improve the contrast characteristic. However, an erroneous discharge occurred at a specific gray level.

### SUMMARY

In one aspect, a method of driving a plasma display apparatus including a scan electrode and a sustain electrode positioned substantially parallel to each other, and an address electrode positioned to intersect the scan electrode and the sustain electrode, the method comprises supplying a first reset signal to the scan electrode during a reset period of a first subfield of a plurality of subfields of a frame, the first subfield being first arranged in the plurality of subfields in time order, and supplying a second reset signal, whose a peak voltage is lower than a peak voltage of the first reset signal, to the scan electrode during reset periods of the remaining subfields except the first subfield when a data signal is not supplied to the address electrode during address periods of the remaining subfields.

In another aspect, a method of driving a plasma display apparatus including a scan electrode and a sustain electrode positioned substantially parallel to each other, and an address electrode positioned to intersect the scan electrode and the sustain electrode, the method comprises supplying a first reset signal, that includes a rising signal with a gradually rising voltage and a falling signal with a gradually falling voltage, to the scan electrode during a reset period of a first subfield of a plurality of subfields of a frame, the first subfield being first arranged in the plurality of subfields in time order, when a data signal is supplied to the address electrode during an address period of at least one of the remaining subfields except the first subfield, supplying a third reset signal including a rising signal with a gradually rising voltage and a falling signal with a gradually falling voltage to the scan electrode during a reset period of the at least one subfield to which the data signal is supplied, and supplying a second reset signal, whose a peak voltage is lower than a peak voltage of the first reset signal, to the scan electrode during reset periods of the remaining subfields, and supplying a second reset signal, whose a peak voltage is lower than a peak voltage of the first reset signal, to the scan electrode during the reset periods of the remaining subfields when a data signal is not supplied to the address electrode during address periods of the remaining subfields.

In yet another aspect, a method of driving a plasma display apparatus including a scan electrode and a sustain electrode positioned substantially parallel to each other, and an address electrode positioned to intersect the scan electrode and the sustain electrode, the method comprises supplying a first reset signal to the scan electrode during a reset period of a first subfield of a plurality of subfields of a frame in a state where all the subfields of the frame are turned off, the first subfield being first arranged in the plurality of subfields in time order, and supplying a second reset signal, whose a peak voltage is lower than a peak voltage of the first reset signal, to the scan electrode during reset periods of the remaining subfields except the first subfield in a state where all the subfields of the frame are turned off.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a plasma display panel according to an exemplary embodiment;

FIG. 2 illustrates a method for representing a gray level of an image in the plasma display panel according to the exemplary embodiment;

FIG. 3 illustrates a plasma display apparatus according to the exemplary embodiment;

FIG. 4 illustrates a method of driving a plasma display apparatus according to a first embodiment;

FIG. 5 illustrates a method of driving a plasma display apparatus according to a second embodiment;

FIG. 6 is a diagram for comparing areas A and B of FIG. 5;

FIG. 7 is a diagram for explaining in detail a first subfield in a method of driving a plasma display apparatus according to a third embodiment;

FIGS. 8A and 8B are diagrams for explaining an example of a case where a second reset signal is omitted;

FIGS. 9 and 10 are diagrams for explaining in detail a first reset signal and a third reset signal;

FIG. 11 illustrates a method of driving a plasma display apparatus according to a fourth embodiment;

FIG. 12 is a diagram for explaining in detail an area A of FIG. 11;

FIG. 13 illustrates a method of driving a plasma display apparatus according to a fifth embodiment;

FIG. 14 is a diagram for explaining in detail an area B of FIG. 11;

FIGS. 15A to 15C illustrate a method of driving a plasma display apparatus according to a sixth embodiment;

FIG. 16 illustrates a method of driving a plasma display apparatus according to a seventh embodiment;

FIG. 17 is a diagram for explaining in detail an area A of FIG. 16; and

FIGS. 18A and 18B are diagrams for explaining in detail a driving waveform depending on the method of driving the plasma display apparatus according to the seventh embodiment.

### DETAILED DESCRIPTION

Reference will now be made in detail embodiments of the invention examples of which are illustrated in the accompanying drawings.

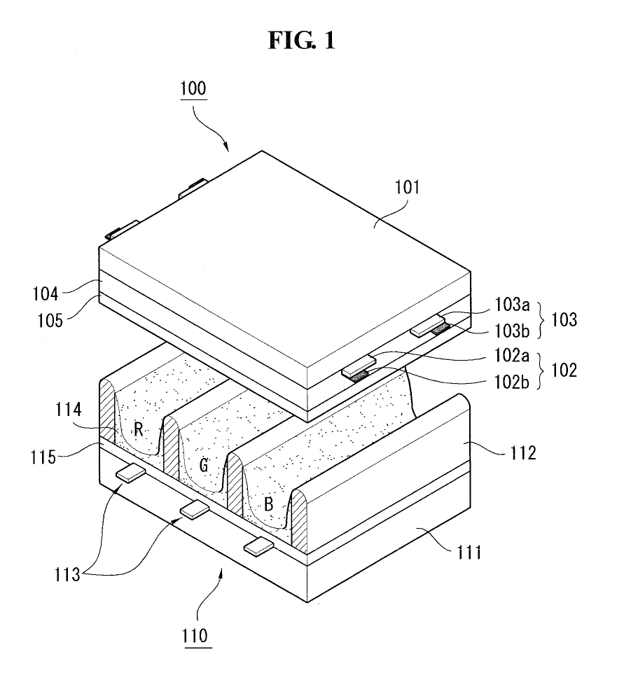

FIG. 1 illustrates a plasma display panel according to an exemplary embodiment.

As shown in FIG. 1, the plasma display panel includes a front panel 100 and a rear panel 110 which coalesce with each other. The front panel 100 includes a front substrate 101 which is a display surface. The rear panel 110 includes a rear substrate 111 constituting a rear surface. A plurality of scan electrodes 102 and a plurality of sustain electrodes 103 are formed in pairs on the front substrate 101, on which an image is displayed, to form a plurality of maintenance electrode pairs. A plurality of address electrodes 113 are arranged on the rear substrate 111 to intersect the plurality of maintenance electrode pairs.

The scan electrode 102 and the sustain electrode 103 each include transparent electrodes 102a and 103a made of a transparent indium-tin-oxide (ITO) material and bus electrodes 102b and 103b made of a metal material. The scan electrode 102 and the sustain electrode 103 generate a mutual discharge therebetween in one discharge cell and maintain light-emissions of discharge cells.

The scan electrode 102 and the sustain electrode 103 are covered with one or more upper dielectric layers 104 for limiting a discharge current and providing insulation between the maintenance electrode pairs. A protective layer 105 with a deposit of magnesium oxide (MgO) is formed on the upper dielectric layer 104 to facilitate discharge conditions.

A plurality of stripe-type or well-type barrier ribs 112 are formed parallel to each other on the rear substrate 111 of the rear panel 110 to form a plurality of discharge spaces, i.e., a plurality of discharge cells. The plurality of address electrodes 113 are positioned parallel to the barrier ribs 112 to perform an address discharge which cause the inert gas to generate vacuum ultraviolet rays.

An upper surface of the rear substrate 111 is coated with red (R), green (G) and blue (B) phosphors 114 for emitting visible light for an image display during the generation of the sustain discharge. A lower dielectric layer 115 is formed between the address electrodes 113 and the phosphors 114 to protect the address electrodes 113.

In the plasma display panel having the above-described structure, the plurality of discharge cells are formed in a matrix form. A driver including a driving circuit for applying a predetermined signal to the discharge cells is attached to the plasma display panel to drive the plasma display panel.

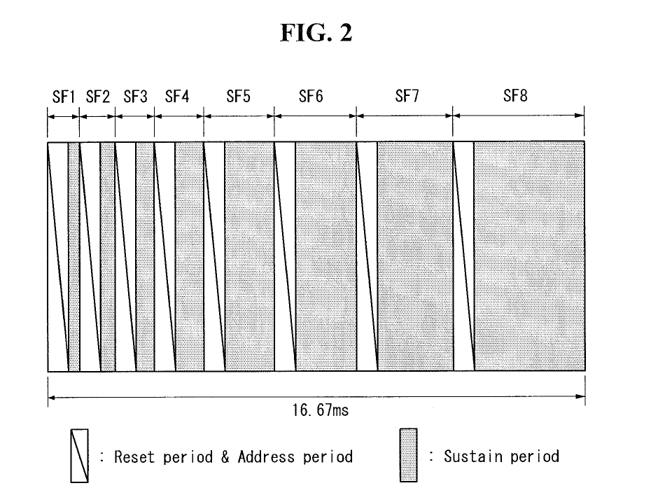

FIG. 2 illustrates a method for representing a gray level of an image in the plasma display panel according to the exemplary embodiment.

As shown in FIG. 2, the plasma display panel is driven with a frame being divided into a plurality of subfields having a different number of emission times. Each subfield is subdivided into a reset period for uniformly generating a discharge, an address period for selecting a discharge cell, and a sustain period for representing a gray level in accordance with the number of discharges.

For example, if an image with 256-gray level is to be displayed, a frame period (for example, 16.67 ms) corresponding to 1/60 sec is divided into eight subfields SF1 to SF8. Each of the eight subfields SF1 to SF8 is subdivided into a reset period, an address period, and a sustain period.

A duration of the reset period in a subfield is equal to a duration of the reset periods in the other subfields. A duration of the address period in a subfield is equal to a duration of the address periods in the other subfields. However, a duration of the sustain period of each subfield may be different from one another, and the number of sustain signals assigned during the sustain period of each subfield may be different from one another. For example, the sustain period increases in a ratio of 2ⁿ (where, n=0, 1, 2, 3, 4, 5, 6, 7) in each of the subfields. Although the above description has been made with respect to a case where one frame includes 8 subfields, it is not limited thereto. One frame may include 10 to 12 subfields.

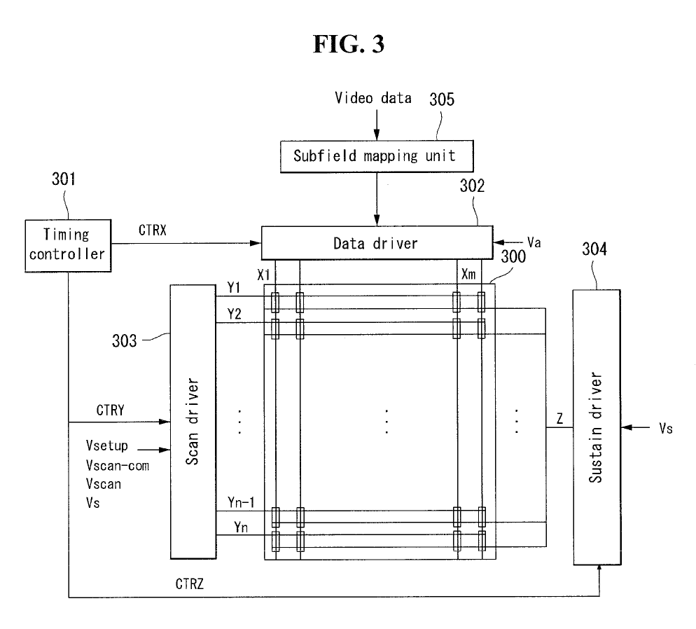

FIG. 3 illustrates a plasma display apparatus according to the exemplary embodiment.

As shown in FIG. 3, the plasma display apparatus according to the exemplary embodiment includes a plasma display panel 300 including a scan electrode, a timing controller 301, a data driver 302, a scan driver 303, a sustain driver 304, and a subfield mapping unit 305.

The timing controller 301 receives a vertical/horizontal synchronization signal and a predetermined clock signal. The controller 121 generates timing control signals CTRX. CTRY and CTRZ for controlling each of the drivers 302, 303 and 304, and applies the timing control signals CTRX, CTRY and CTRZ to the corresponding drivers 302, 303 and 304, respectively.

Accordingly, the timing controller 301 controls operations of the drivers 302, 303 and 304. Further, the timing controller 301 controls the scan driver 303 to apply a reset signal including only a falling signal to the scan electrodes Y1 to Yn during a portion of a plurality of subfields. This results in the prevention of an erroneous discharge caused by an unstable discharge.

The data driver 122 applies a data signal, which is sampled and latched in response to the timing control signal CTRX received from the timing controller 301, to the address electrodes X1 to Xm.

Under the control of the timing controller 301, the scan driver 303 controls the reset signal supplied to the scan electrodes Y1 to Yn during a reset period.

Under the control of the timing controller 301, the scan driver 303 consecutively applies scan signals with a scan voltage −Vy to the scan electrodes Y1 to Yn during an address period.

Under the control of the timing controller 301, the sustain driver 304 applies a bias voltage of a sustain voltage Vs to the sustain electrodes Z during a set-down period of the reset period and the address period. The scan driver 303 and the sustain driver 304 alternatively operate during a sustain period to apply a sustain signal to the scan electrodes Y1 to Yn and the sustain electrodes Z.

The last sustain discharge ends in one subfield, and then the sustain driver 304 may apply an erase signal to the sustain electrodes Z.

The subfield mapping unit 305 maps video data, which is processed through a predetermined imaging process, for each subfield, and then outputs the mapped video data.

For example, the subfield mapping unit 305 maps video data for each subfield, after performing a motion process, an average power level (APL) process, an half-tone correction process, and the like, on video data input from an external signal processor (not shown), for example, a video signal controller (VSC) chip (not shown). Then, the subfield mapping unit 305 produces the mapped video data and outputs it.

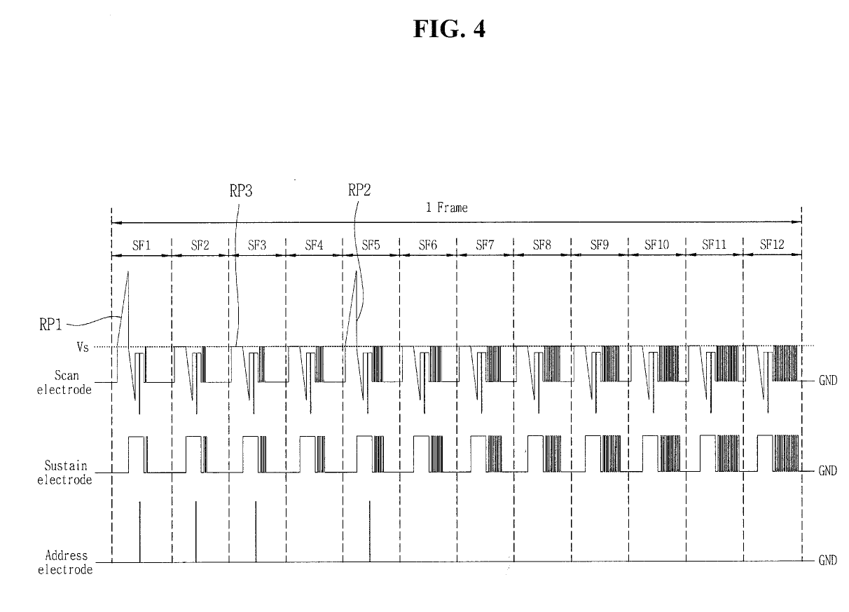

FIG. 4 illustrates a method of driving a plasma display apparatus according to a first embodiment.

As shown in FIG. 4, the driving method of the plasma display apparatus according to the first embodiment displays an image during a plurality of frames, and each frame is divided into a plurality of subfields having a different number of emission times. Each frame may be divided into 10 or 12 subfields having a different number of emission times.

The driving method according to the first embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the first embodiment includes applying a first reset signal RP1 including a rising signal and a falling signal to the scan electrode during a reset period of a subfield (for example, a first subfield SF1) of the lowest gray level weight, and applying a third reset signal RP3 including only a falling signal to the scan electrode in a subfield except the first subfield SF1.

The falling signal of third reset signal RP3 is maintained at a sustain voltage Vs being a bias voltage, and then falls from the sustain voltage Vs. A contrast characteristic is improved by reducing the number of applications of a rising signal with a high voltage.

In case that a rising signal is supplied once during one frame, an erroneous discharge may occur at a specific gray level. To prevent the erroneous discharge, a second reset signal RP2 including a rising signal and a falling signal is supplied to the scan electrode during a reset period of a turn-on subfield next to a turn-off subfield.

For example, in case that all subfields of one frame are turned on, one subfield of subfields with a relative low gray level weight may be unstable. However, since all the subfields following the unstable subfield have been turned on, a stable discharge occurs due to discharges of many sustain signals.

However, as shown in FIG. 4, if three subfields SF1-SF3 in subfields SF1-SF5 of a relative low gray level weight are turned on and the fifth subfield SF5 is turned on, the number of sustain signals generated in the subfields following the turn-on subfield SF3 is not sufficient. This results in the generation of an erroneous discharge in the turn-on subfield SF5.

The generation of an erroneous discharge in the turn-on subfield SF5 is prevented by applying the second reset signal RP2 including the rising signal and the falling signal in the turn-on subfield SF5 next to the unstable subfield SF3.

Although the subfields SF1, SF2, SF3 and SF5 as a turn-on subfield were optionally set in FIG. 4 for the easy explanation, the first embodiment is not limited thereto.

For example, it is assumed that the first subfield SF1 is turned on and the fifth subfield SF5 is turned on again, the third reset signal RP3 including only the falling signal is supplied during reset periods of the second to fourth subfields SF2-SF4. Therefore, it is a great likelihood of the generation of an erroneous discharge in the fifth subfield SF5.

Accordingly, the second reset signal RP2 including the rising signal and the falling signal is supplied in the fifth subfield SF5 such that the generation of the erroneous discharge is prevented in the fifth subfield SF5.

In the first embodiment, the subfields during which the third reset signal RP3 is supplied may be a low gray level subfield. The low gray level subfield may range from the first to fourth subfields SF1-SF4 in the subfields SF1-SF12 of one frame arranged in an increasing order of gray level weight.

The subfields during which the second reset signal RP2 is supplied may range from the fifth to twelfth subfields SF5-SF12 in the subfields SF1-SF12 of one frame arranged in an increasing order of gray level weight.

If the first reset signal RP1 including the rising signal and the falling signal is supplied in the subfield SF1 of the lowest gray level and the third reset signal RP3 including only the falling signal is supplied in the first to fourth subfields SF1-SF4 in the subfields SF1-SF12 of one frame arranged in an increasing order of gray level weight, it is a great likelihood of the generation of the erroneous discharge due to the unstable discharge. Therefore, the second reset signal RP2 is supplied in the fifth to twelfth subfields SF5-SF12 in the subfields SF1-SF12 of one frame arranged in an increasing order of gray level weight.

Accordingly, the number of rising signals supplied during one frame is reduced considerably such that a contrast characteristic is improved and an erroneous discharge at a specific gray level is prevented.

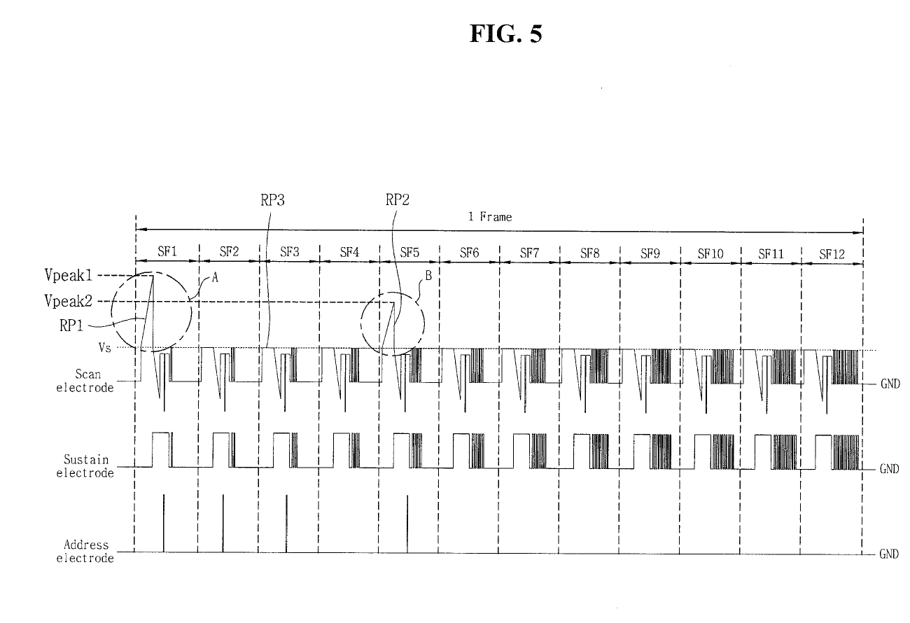

FIG. 5 illustrates a method of driving a plasma display apparatus according to a second embodiment.

As shown in FIG. 5, a first reset signal RP1 and a second reset signal RP2 are supplied during a reset period of a subfield SF1 having a lowest gray level weight and a reset period of a turn-on subfield SF5 next to a turn-off subfield SF4 of a plurality of subfields SF1-SF12, respectively, so that a peak voltage Vpeak1 of a rising signal of the first reset signal RP1 is higher than a peak voltage Vpeak2 of a rising signal of the second reset signal RP2.

In the first embodiment illustrated in FIG. 4, to prevent the generation of the erroneous discharge, a peak voltage of the rising signal of the first reset signal RP1 supplied during the reset period of the lowest gray level subfield SF1 is equal to a peak voltage of the rising signal of the second reset signal RP2 supplied during the reset period of the fifth subfield SF5. However, unlike the first embodiment, in FIG. 5, the generation of a flicker is prevented by applying the second reset signal RP2 having the peak voltage Vpeak2, that is lower than the peak voltage Vpeak1 of the first reset signal RP1 supplied during the reset period of the lowest gray level subfield SF1, during the reset period of the turn-on subfield SF5 next to the turn-off subfield SF4.

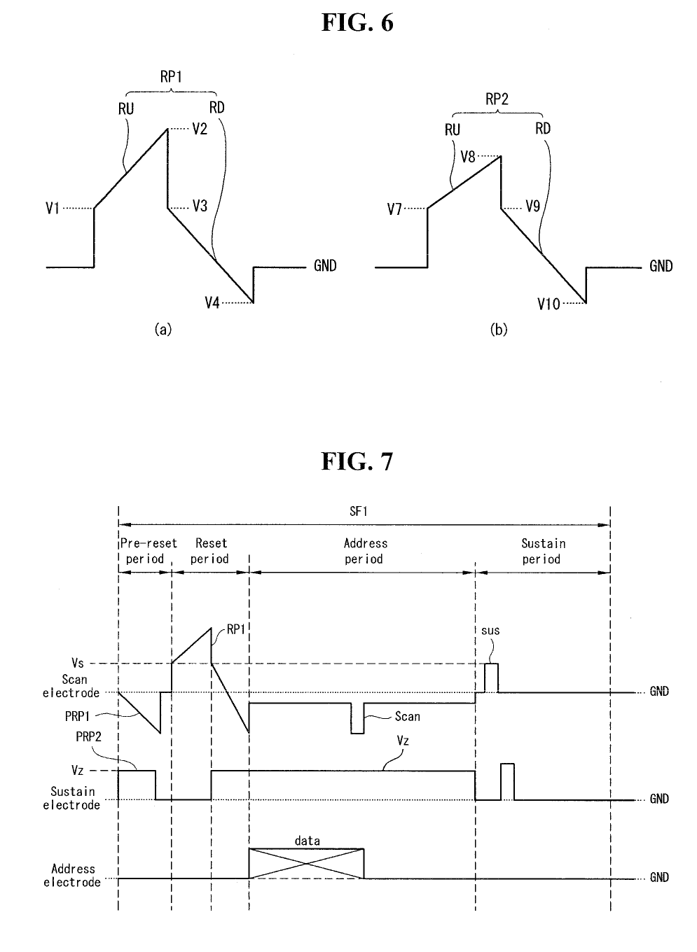

FIG. 6 is a diagram for comparing areas A and B of FIG. 5. As shown in FIG. 6, a rising signal RU of the first reset signal RP1 may gradually rise from a first voltage V1 higher than a ground level voltage GND to a second voltage V2. A falling signal RD of the first reset signal RP1 may gradually fall from a third voltage V3 lower than the second voltage V2 to a fourth voltage V4 lower than the ground level voltage GND.

Further, a rising signal RU of the second reset signal RP2 may gradually rise from a seventh voltage V7 higher than the ground level voltage GND to an eighth voltage V8. A falling signal RD of the second reset signal RP2 may gradually fall from a ninth voltage V9 higher than the ground level voltage GND to a tenth voltage V10 lower than the ground level voltage GND.

A peak voltage (i.e., the second voltage V2) of the first reset signal RP1 may be higher than a peak voltage (i.e., the eighth voltage V8) of the second reset signal RP2.

The first voltage V1 may be substantially equal to the seventh voltage V7. The first voltage V1 may be substantially equal to the third voltage V3. The seventh voltage V7 may be substantially equal to the ninth voltage V9. The fourth voltage V4 may be substantially equal to the tenth voltage V10. The fourth and tenth voltages V4 and V10 may be higher than a lowest voltage of the scan signal supplied to the scan electrode during the address period.

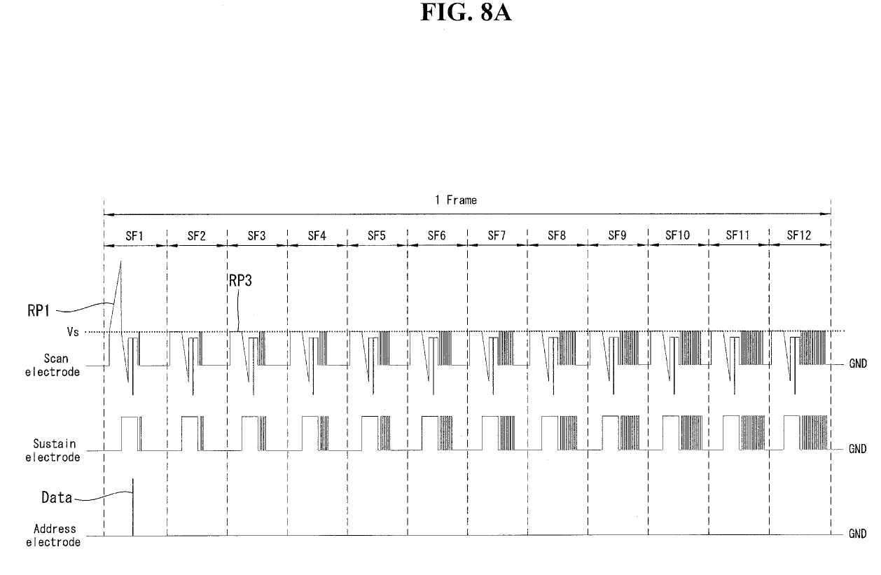

FIG. 7 is a diagram for explaining in detail a first subfield in a method of driving a plasma display apparatus according to a third embodiment.

As shown in FIG. 7, before a first reset signal RP1 having a rising signal and a falling signal is supplied to the scan electrode during a reset period of a first subfield SF1 as shown in FIGS. 4 and 5, a first pre-reset signal PRP1 is supplied to the scan electrode and a second pre-reset signal PRP2 of a polarity opposite a polarity of the first pre-reset signal PRP1 is supplied to the sustain electrode correspondingly to the first pre-reset signal PRP1.

The first pre-reset signal PRP1 is a negative polarity, and may be a falling signal gradually falling from a ground level voltage GND. The second pre-reset signal PRP2 is a positive polarity and may be a square wave.

As above, since the first and second pre-reset signals PRP1 and PRP2 are supplied prior to the reset period of the first subfield SF1, a peak voltage of the rising signal of the first reset signal RP1 supplied during the reset period of the first subfield SF1 is lowered. This results in a reduction in a black level luminance in a reset process.

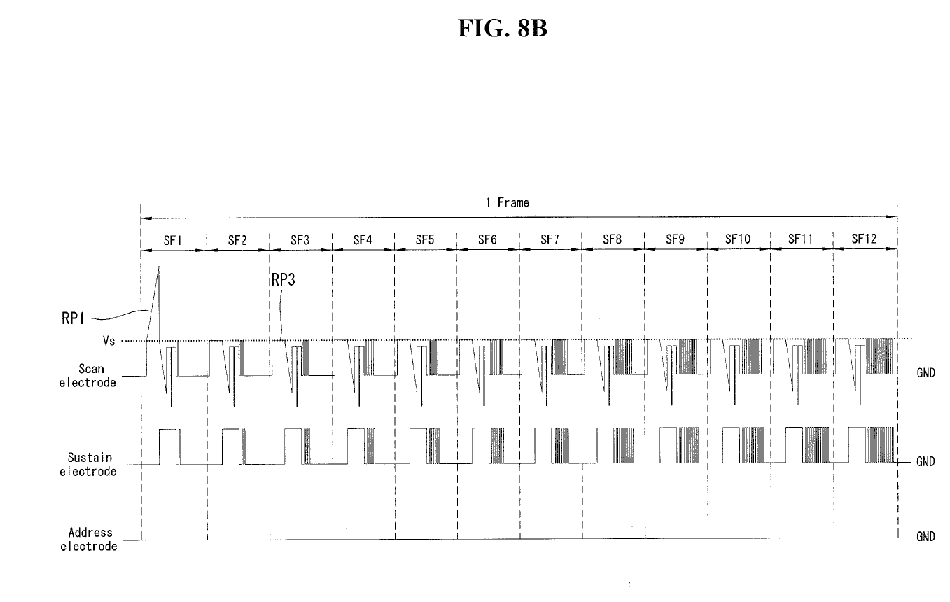

FIGS. 8A and 8B are diagrams for explaining an example of a case where a second reset signal is omitted.

As shown in FIG. 8A, a first reset signal RP1 is supplied to the scan electrode during a reset period of a first subfield SF1 of a plurality of subfields SF1 to SF12 of a frame, and a data signal is not supplied to the address electrode during address periods of the remaining subfields SF2 to SF12 except the first subfield SF1. The first subfield SF1 is first arranged in time order in the frame. In this case, a third reset signal RP3, whose a peak voltage is lower than a peak voltage of the first reset signal RP1, is supplied to the scan electrode during reset periods of the remaining subfields SF2 to SF12.

In other words, in case that the first subfield SF1 is turned on and the remaining subfields SF2 to SF12 are turned off, the first reset signal RP1 is supplied to the scan electrode in the first subfield SF1 and the third reset signal RP3 is supplied to the scan electrode in the remaining subfields SF2 to SF12.

In case that the remaining subfields SF2 to SF12 are turned off (i.e., in case that the data signal is not supplied to the address electrode in the remaining subfields SF2 to SF12), an address discharge and a sustain discharge do not occur.

Therefore, there is a small likelihood of the generation of an unstable discharge. Accordingly, although the third reset signal RP3 is supplied to the scan electrode in the remaining subfields SF2 to SF12, the discharge is not unstable. Further, the contrast characteristic can be further improved.

As shown in FIG. 8B, all of subfields SF1 to SF12 of a frame are turned off. In this case, a first reset signal RP1 is supplied to the scan electrode during a reset period of a first subfield SF1 (first arranged in time order), and a third reset signal RP3, whose a peak voltage is lower than a peak voltage of the first reset signal RP1, is supplied to the scan electrode during reset periods of the remaining subfields SF2 to SF12. Hence, the contrast characteristic can be further improved.

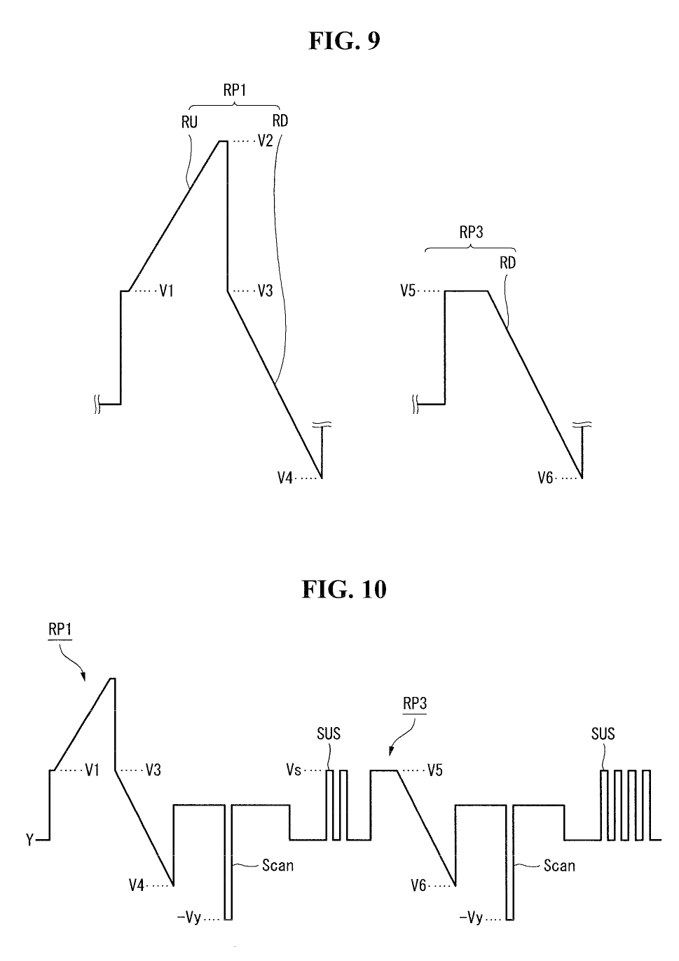

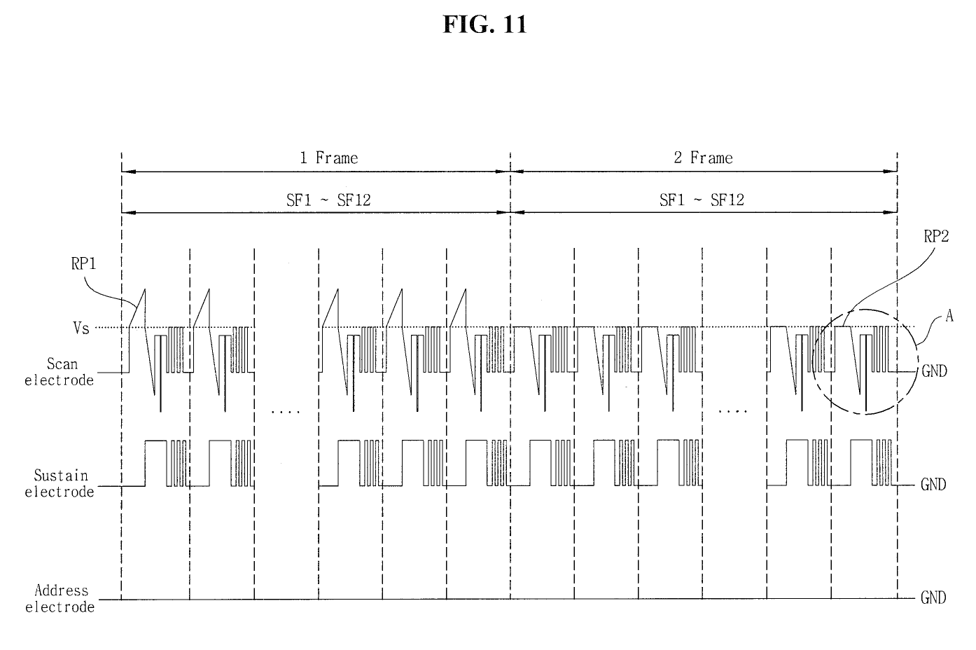

FIGS. 9 and 10 are diagrams for explaining in detail a first reset signal and a third reset signal.

As shown in FIG. 9, the first reset signal RP1 may include a rising signal RU which gradually rises from a first voltage V1 higher than the ground level voltage GND to a second voltage V2, and a falling signal RD which gradually falls from a third voltage V3 lower than the second voltage V2 to a fourth voltage V4 lower than the ground level voltage GND.

Further, the third reset signal RP3 may include a falling signal RD which gradually falls from a fifth voltage V5 higher than the ground level voltage GND to a sixth voltage V6 lower than the ground level voltage GND. The third reset signal RP3 may not include a rising signal with a gradually rising voltage.

The third voltage V3 may be substantially equal to the fifth voltage V5. The fourth voltage V4 may be substantially equal to the sixth voltage V6. The first voltage V1 may be substantially equal to the third voltage V3.

As shown in FIG. 10, the third and fifth voltages V3 and V5 may be substantially equal to a voltage Vs of a sustain signal SUS supplied to at least one of the scan electrode or the sustain electrode during a sustain period following the address period.

The fourth and sixth voltages V4 and V6 may be higher than a lowest voltage −Vy of a scan signal Scan supplied to the scan electrode during the address period. Hence, a set-down discharge can be stabilized.

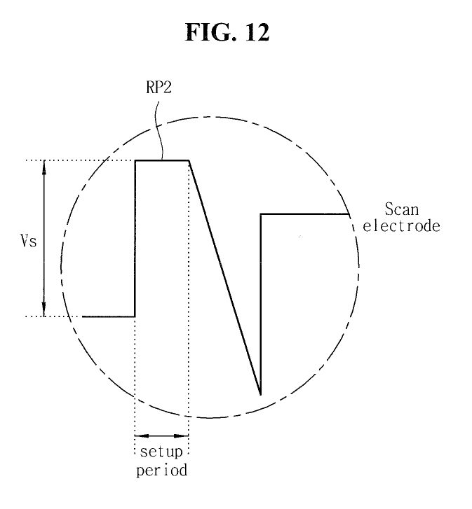

FIG. 11 illustrates a method of driving a plasma display apparatus according to a fourth embodiment.

As shown in FIG. 11, the driving method of the plasma display apparatus according to the fourth embodiment displays an image during a plurality of frames, and each frame is divided into a plurality of subfields having a different number of emission times. Each frame may be divided into 10 or 12 subfields having a different number of emission times.

The driving method according to the fourth embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the fourth embodiment applies a first reset signal RP1 including a rising signal and a falling signal to the scan electrode during a reset period of each of subfields SF1-SF12 of a first frame.

Then, in case that a second frame following the first frame is an OFF-cell, a second reset signal RP2 including only a falling signal is supplied to the scan electrode during a reset period of each of subfields SF1-SF12 of the second frame.

For example, if the first frame corresponding to a portion of a display surface (not shown) of the plasma display panel is an ON-cell, the first reset signal RP1 is supplied in the twelve subfields SF1-SF12 of the first frame, and the second frame is the OFF-cell in the whole panel, a window pattern displayed on the portion of the panel display surface appears as an image retention pattern.

Accordingly, when there is a movement from the ON-cell first frame to the OFF-cell second frame, the second reset signal RP2 including only the falling signal is supplied in all the subfields SF1 to SF12 of the second frame.

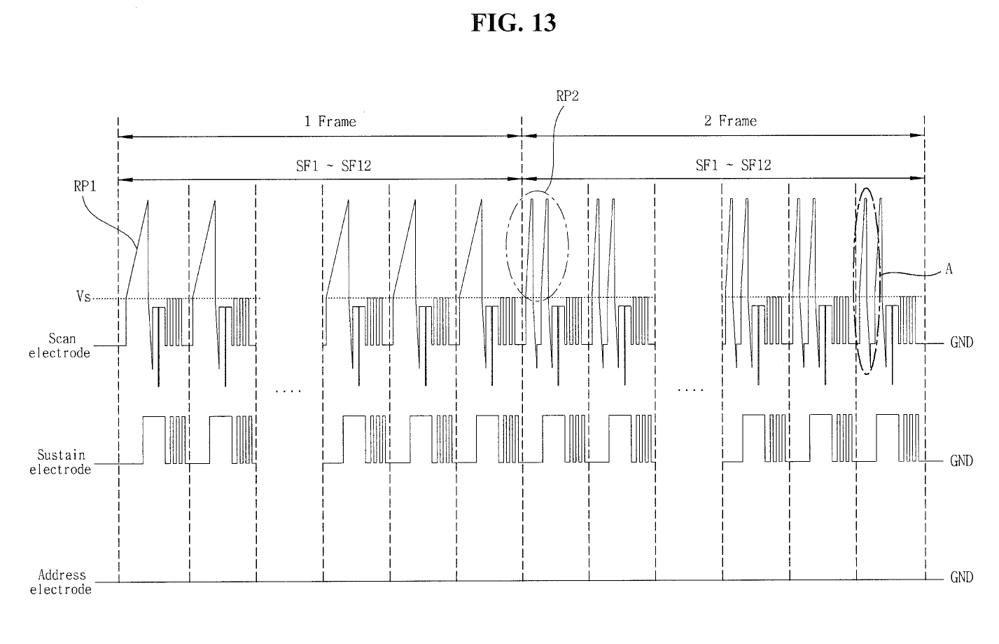

FIG. 12 is a diagram for explaining in detail an area A of FIG. 11. As shown in FIG. 12, the second reset signal RP2 supplied in all the subfields SF1 to SF12 of the second frame includes only the falling signal.

The falling signal is maintained at a sustain voltage Vs being a bias voltage, and then gradually falls from the sustain voltage Vs.

As above, since the second reset signal RP2 supplied in the second frame has a luminance of about 0 cd/m² based on one signal as compared with the first reset signal RP1 having a luminance of about 0.1 cd/m² or more based on one signal, when there is the movement from the ON-cell first frame to the OFF-cell second frame the application of the second reset signal RP2 can lower an image retention level and a contrast characteristic can be improved.

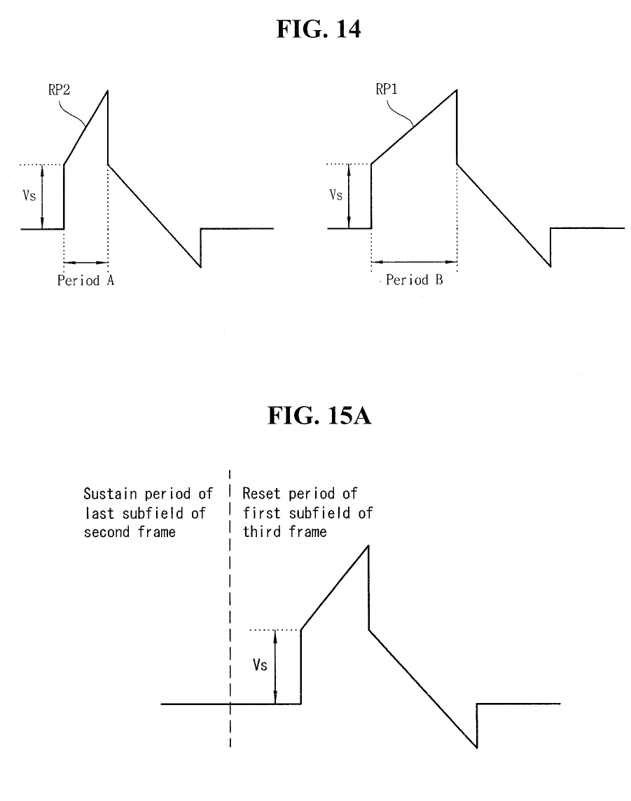

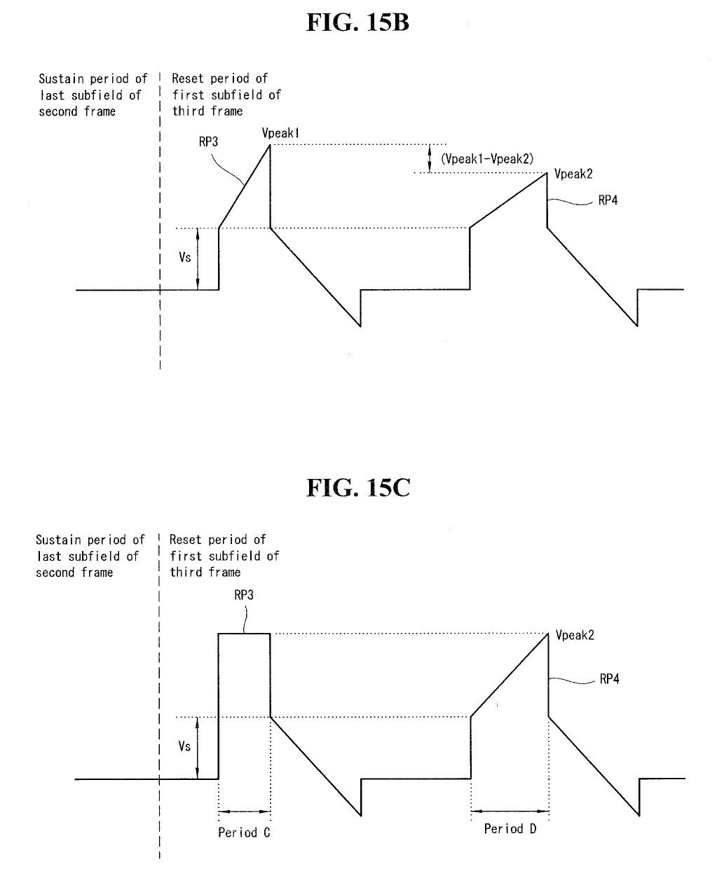

FIG. 13 illustrates a method of driving a plasma display apparatus according to a fifth embodiment, and FIG. 14 is a diagram for explaining in detail an area B of FIG. 11.

As shown in FIG. 13, the driving method according to the fifth embodiment applies a first reset signal RP1 including a rising signal and a falling signal to the scan electrode during a reset period of each of subfields SF1-SF12 of a first frame.

Then, in case that a second frame following the first frame is an OFF-cell, a second reset signal RP2 including at least two rising signals is supplied to the scan electrode during reset periods of all subfields SF1-SF12 of the second frame.

As shown in FIG. 14, a time period A in all the subfields SF1-SF12 of the second frame during which one rising signal of the second reset signal RP2 is supplied is shorter than a time period B in the subfields SF1-SF12 of the first frame during which the rising signal of the first reset signal RP1 is supplied.

The number of rising signals supplied in all the subfields SF1-SF12 of the second frame may range from 1 to 3 in each subfield of the second frame.

Since the rising signals supplied in the subfields of the first frame has a luminance of about 0.1 cd/m² based on one signal, a flicker may occur due to the luminance deviation when an ON-cell and an OFF-cell are alternately varied to each other such that a contrast characteristic may worsen.

Accordingly, a weak discharge occurs several times by applying the second reset signal RP2 including the 2 or 3 rising signals having a luminance of about 0.04 cd/m² based on one signal. As a result, several weak discharges lower a level of dark image retention as compared with one strong discharge, and the generation of the flicker due to the luminance deviation is prevented.

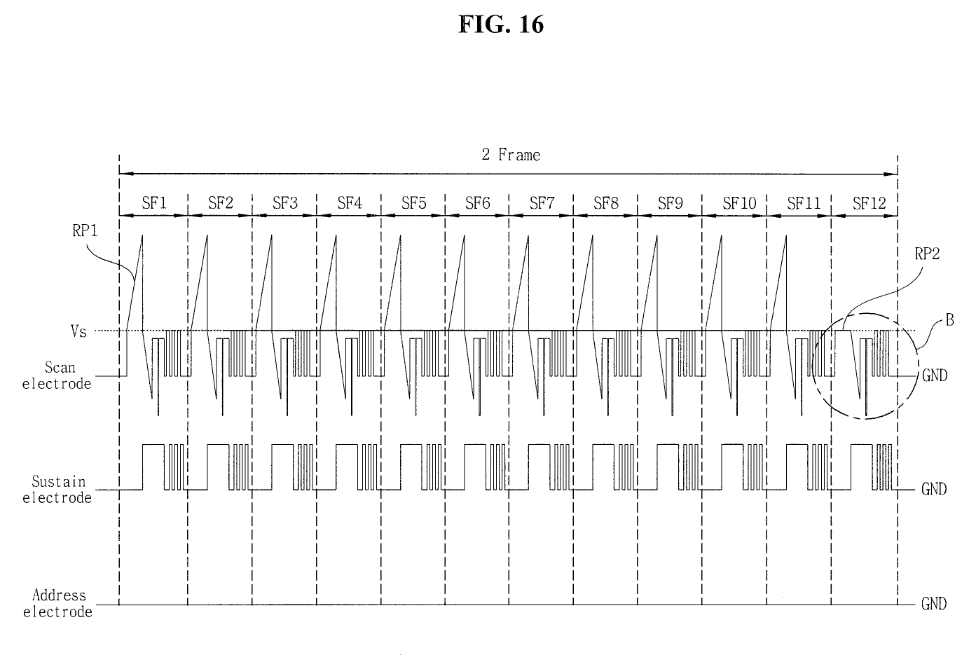

FIGS. 15A to 15C illustrate a method of driving a plasma display apparatus according to a sixth embodiment.

FIG. 15A illustrates a related art reset signal supplied during a last subfield of a second frame and a first subfield of a third frame next to the second frame.

As shown in FIG. 15A, after a second reset signal shown in FIGS. 11 and 13 is supplied in the second frame, one reset signal is supplied during a reset period of the first subfield of the third frame next to the second frame. In this case, it is difficult to vary a discharge when there is a movement from the OFF-cell second frame to the ON-cell third frame.

FIG. 15B illustrates a reset signal according to the sixth embodiment supplied during a last subfield of a second frame and a first subfield of a third frame next to the second frame. As shown in FIG. 15B, a third reset signal RP3 and a fourth reset signal RP4 are supplied in the first subfield of the third frame.

The third reset signal RP3 and the fourth reset signal RP4 each include a rising signal.

A first peak voltage Vpeak1 of the third reset signal RP3 is higher than a second peak voltage Vpeak2 of the fourth reset signal RP4.

A difference (Vpeak1−Vpeak2) between the first peak voltage Vpeak1 and the second peak voltage Vpeak2 may be equal to or less than 100V.

As above, since the third reset signal RP3 that is higher than the fourth reset signal RP4 by 100V or less is supplied, the unstableness of discharge generated when there is a movement from the OFF-cell second frame to the ON-cell third frame can be solved.

A third reset signal RP3 having a different form from the third reset signal RP3 shown in FIG. 15B may be supplied. This will be below described with reference to FIG. 15C.

As shown in FIG. 15C, the third reset signal RP3 supplied in the first subfield of the third frame may include a square wave.

A voltage of the square wave is equal to the second peak voltage Vpeak2 of the fourth reset signal RP4. A time period C during which the square wave of the third reset signal RP3 is supplied is shorter than a time period D during which the rising signal of the fourth reset signal RP4 is supplied.

As above, since the third reset signal RP3 is supplied during the time period C shorter than the time period D during which the fourth reset signal RP4 is supplied, the unstableness of discharge is solved when there is a movement from the OFF-cell second frame to the ON-cell third frame.

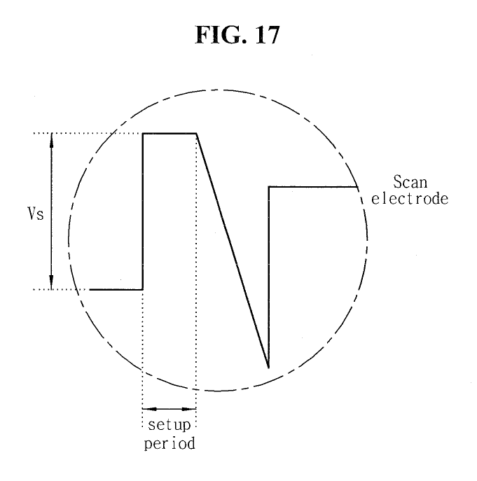

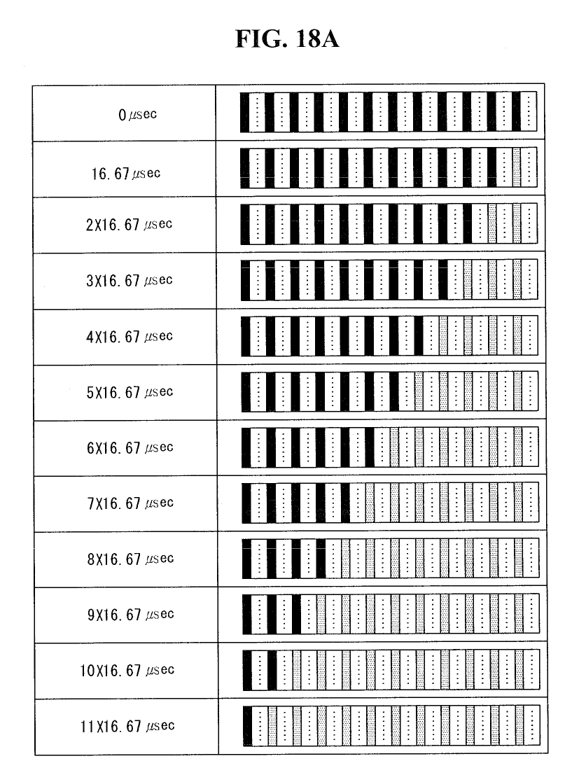

FIG. 16 illustrates a method of driving a plasma display apparatus according to a seventh embodiment, and FIG. 17 is a diagram for explaining in detail an area A of FIG. 16.

As shown in FIG. 16, the driving method of the plasma display apparatus according to the seventh embodiment displays an image during a plurality of frames, and each frame is divided into a plurality of subfields having a different number of emission times. Each frame may be divided into 10 or 12 subfields having a different number of emission times.

The driving method according to the seventh embodiment is preformed with each subfield being subdivided into a reset period for initializing the whole screen, an address period for selecting cells to be discharged, a sustain period for maintaining discharges of the selected cells, and an erase period for erasing wall charges within the discharged cells.

The driving method according to the seventh embodiment applies a first reset signal RP1 including a rising signal and a falling signal to the scan electrode during a reset period of each of subfields SF1-SF12 of a first frame.

Then, in case that a second frame following the first frame is an OFF-cell, a second reset signal RP2 including only a falling signal instead of the first reset signal RP1 is supplied to the scan electrode during a reset period of at least one subfield (for example, a twelfth subfield SF12 in FIG. 16) of the second frame.

For example, if the first frame is an ON-cell, the 12 first reset signals RP1 are supplied in the 12 subfields of the first frame, respectively. Then, if the second frame is an OFF-cell, an image retention pattern appears in the second frame.

When there is a movement from the first frame of the ON-cell to the second frame of the OFF-cell, the second reset signal RP2 starts to be supplied from the last subfield SF12 of the second frame.

In other words, if the second frame includes 12 subfields, the first reset signal RP1 is supplied in 11 subfields of the second frame and the second reset signal RP2 is supplied in the remaining one subfield.

Subsequently, if a third frame following the second frame is an OFF-cell, the first reset signal RP1 is supplied in 10-subfields of the third frame and the second reset signal RP2 is supplied in the remaining two subfields.

In other words, in case that a OFF-cell frame continuously changes to OFF-cell frame, the number of second reset signals may increase by one every time there is a movement from a frame to a next frame.

As shown in FIG. 17, the second reset signal RP2 supplied instead of the first reset signal RP1 in at least one subfield of the second frame includes only the falling signal.

The falling signal is maintained at a sustain voltage Vs being a bias voltage, and gradually falls from the sustain voltage Vs.

since the second reset signal RP2 including only the falling signal has a luminance of about 0 cd/m² based on one signal as compared with the first reset signal RP1 having a luminance of about 0.1 cd/m² or more based on one signal, when there is the movement from the ON-cell first frame to the OFF-cell second frame the application of the second reset signal RP2 can lower an image retention level.

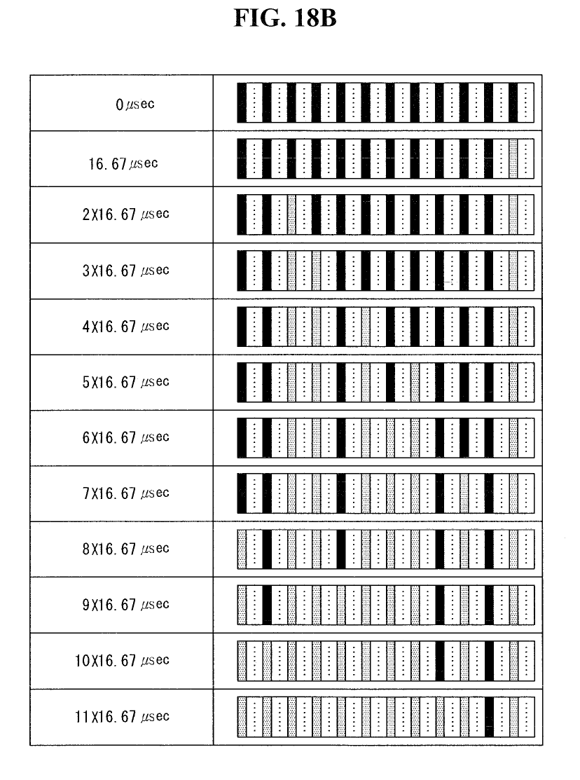

FIGS. 18A and 18B are diagrams for explaining in detail a driving waveform depending on the method of driving the plasma display apparatus according to the seventh embodiment.

As shown in FIG. 18A, the second reset signal RP2 supplied in at least one subfield of the second frame may be supplied in reverse order from a subfield of the highest gray level weight.

For example, if one frame includes 12 subfields and a subsequent frame of a first frame of an ON-cell is an OFF-cell, the second reset signal RP2 is supplied during a reset period of a last subfield SF12 of the subsequent frame.

If a subsequent frame of a frame of an OFF-cell is an OFF-cell, the second reset signal RP2 is supplied during a reset period of a last subfield SF12 of the subsequent frame and an eleventh subfield SF11 in reverse order from the last subfield SF12. Accordingly, the increasing number of frames of an OFF-cell is proportional to the increasing number of second reset signals RP2.

On the other hand, if a subsequent frame of a frame of an OFF-cell is an ON-cell, the first reset signal RP1 is supplied in all subfields of the subsequent frame.

When an OFF-cell frame continuously moves to an OFF-cell frame, the number of first reset signals RP1 is reduced and the number of second reset signals RP2 increases. However, at least one first reset signals RP1 may be supplied during one frame.

For example, in case that all of second to fifteenth frames following a first frame of an ON-cell are an OFF-cell, the first reset signals RP1 is supplied in one subfield of the eleventh frame and the second reset signals RP2 is supplied in the remaining 11 subfields of the eleventh frame. Subsequently, the second reset signals RP2 is not supplied in all subfields of the twelfth frame of the OFF-cell. In the same way as the eleventh frame, the first reset signals RP1 is supplied in one subfield of the twelfth frame and the second reset signals RP2 is supplied in the remaining 11 subfields of the twelfth frame.

As above, since the second reset signal RP2 is supplied in reverse order from a subfield of the highest gray level weight, the generation of an erroneous discharge is prevented and time required in removing dark image retention is reduced.

The second reset signal RP2 may be supplied in another way. This will be described with reference to FIG. 18B.

As shown in FIG. 18B, every time there is a movement from a frame to a next frame, the second reset signal RP2 supplied in at least one subfield of the second frame may be supplied irrespective of the order of subfield.

For example, if each frame includes 12 subfields and a subsequent frame of a first frame of an ON-cell is an OFF-cell, the second reset signal RP2 may be supplied during a reset period of a last subfield SF12 of the subsequent frame, and the second reset signal RP2 may be supplied during a reset period of a tenth subfield SF10 of the subsequent frame.

Subsequently, if a subsequent frame of a frame of an OFF-cell is an OFF-cell, the second reset signal RP2 may be supplied during a reset period of a third subfield SF3 of the subsequent frame. Accordingly, the increasing number of frames of an OFF-cell is proportional to the increasing number of second reset signals RP2.

On the other hand, when there is a movement from an OFF-cell frame to an ON-cell frame, the first reset signal RP1 is supplied in all subfields of the ON-cell frame.

Accordingly, the generation of an erroneous discharge is prevented and time required in removing dark image retention is reduced.

The foregoing embodiments and advantages are merely exemplary and are not to be construed as limiting the present invention. The present teaching can be readily supplied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus including a scan electrode and a sustain electrode positioned substantially parallel to each other, and an address electrode positioned to intersect the scan electrode and the sustain electrode, the method comprising;
supplying a first reset signal to the scan electrode during a reset period of a first subfield of a plurality of subfields of a frame, the first subfield being first arranged in the plurality of subfields in time order; and
supplying a second reset signal, whose a peak voltage is lower than a peak voltage of the first reset signal, to the scan electrode during reset periods of the remaining subfields except the first subfield when a data signal is not supplied to the address electrode during address periods of the remaining subfields.

2. The method of claim 1, wherein the first reset signal includes a rising signal that gradually rises from a first voltage higher than a ground level voltage to a second voltage, and a falling signal that gradually falls from a third voltage lower than the second voltage to a fourth voltage lower than the ground level voltage, and
the second reset signal includes a falling signal that gradually falls from a fifth voltage higher than the ground voltage to a sixth voltage lower than the ground level voltage, and the second reset signal does not include a rising signal with a gradually rising voltage.

3. The method of claim 2, wherein the third voltage is substantially equal to the fifth voltage.

4. The method of claim 3, wherein the third and fifth voltages are substantially equal to a voltage of a sustain signal supplied to at least one of the scan electrode or the sustain electrode during a sustain period following the address period.

5. The method of claim 2, wherein the fourth voltage is substantially equal to the sixth voltage.

6. The method of claim 2, wherein the fourth voltage and the sixth voltage are higher than a lowest voltage of a scan signal supplied to the scan electrode during the address period.

7. The method of claim 1, wherein the first subfield has a lowest gray level weight.

8. A method of driving a plasma display apparatus including a scan electrode and a sustain electrode positioned substantially parallel to each other, and an address electrode positioned to intersect the scan electrode and the sustain electrode, the method comprising:
supplying a first reset signal, that includes a rising signal with a gradually rising voltage and a falling signal with a gradually falling voltage, to the scan electrode during a reset period of a first subfield of a plurality of subfields of a frame, the first subfield being first arranged in the plurality of subfields in time order;
when a data signal is supplied to the address electrode during an address period of at least one of the remaining subfields except the first subfield, supplying a third reset signal including a rising signal with a gradually rising voltage and a falling signal with a gradually falling voltage to the scan electrode during a reset period of at least one of the at least one subfield to which the data signal is supplied, and supplying a second reset signal, whose a peak voltage is lower than a peak voltage of the first reset signal, to the scan electrode during reset periods of the remaining subfields except the subfields in which the first and third reset signals are supplied; and
supplying a second reset signal, whose a peak voltage is lower than a peak voltage of the first reset signal, to the scan electrode during the reset periods of the remaining subfields except the first subfield when a data signal is not supplied to the address electrode during address periods of the remaining subfields except the first subfield.

9. The method of claim 8, wherein the second reset signal includes a falling signal with a gradually falling voltage, and does not include a rising signal with a gradually rising voltage.

10. The method of claim 9, wherein the rising signal of the first reset signal gradually rises from a first voltage higher than a ground level voltage to a second voltage, and the falling signal of the first reset signal gradually falls from a third voltage lower than the second voltage to a fourth voltage lower than the ground level voltage,
the falling signal of the second reset signal gradually falls from a fifth voltage higher than the ground level voltage to a sixth voltage lower than the ground level voltage, and
the rising signal of the third reset signal gradually rises from a seventh voltage higher than the ground level voltage to an eighth voltage, and the falling signal of the third reset signal gradually falls from a ninth voltage higher than the ground level voltage to a tenth voltage lower than the ground level voltage.

11. The method of claim 10, wherein the third, fifth, and ninth voltages are substantially equal to one another.

12. The method of claim 11, wherein the third, fifth, and ninth voltages are substantially equal to a voltage of a sustain signal supplied to at least one of the scan electrode or the sustain electrode during a sustain period following the address period.

13. The method of claim 10, wherein the fourth, sixth, and tenth voltages are substantially equal to one another.

14. The method of claim 2, wherein the fourth, sixth, and tenth voltages are higher than a lowest voltage of a scan signal supplied to the scan electrode during the address period.

15. The method of claim 10, wherein the eighth voltage is substantially equal to or lower than the second voltage.

16. The method of claim 10, wherein the first subfield has a lowest gray level weight.

17. A method of driving a plasma display apparatus including a scan electrode and a sustain electrode positioned substantially parallel to each other, and an address electrode positioned to intersect the scan electrode and the sustain electrode, the method comprising:
supplying a first reset signal to the scan electrode during a reset period of a first subfield of a plurality of subfields of a frame when all the subfields of the frame are turned off, the first subfield being first arranged in the plurality of subfields in time order; and
supplying a second reset signal, whose a peak voltage is lower than a peak voltage of the first reset signal, to the scan electrode during reset periods of the remaining subfields except the first subfield when all the subfields of the frame are turned off.

18. The method of claim 17, wherein the first reset signal includes a rising signal that gradually rises from a first voltage higher than a ground level voltage to a second voltage, and a falling signal that gradually falls from a third voltage lower than the second voltage to a fourth voltage lower than the ground level voltage, and
the second reset signal includes a falling signal that gradually falls from a fifth voltage higher than the ground voltage to a sixth voltage lower than the ground level voltage, and the second reset signal does not include a rising signal with a gradually rising voltage.

19. The method of claim 10, wherein the third voltage is substantially equal to the fifth voltage.

20. The method of claim 17, wherein the first subfield has a lowest gray level weight.
